(19) United States
(12) Patent Application Publication
(10) Pub. No.: US 2016/0078439 A1
(43) Pub. Date: Mar. 17, 2016

(54) Method and an Arrangement for Exception Management in a Transaction Network

(71) Applicant: Basware Oyj, Espoo (FI)

(72) Inventors: Mika VANSKA, Espoo (FI); Timo HOTTI, Espoo (FI)

(21) Appl. No.: 14/847,116

(22) Filed: Sep. 8, 2015

(30) Foreign Application Priority Data
Sep. 12, 2014 (FI) 20140246

(51) Int. Cl. G06Q 20/40

(52) U.S. Cl. CPC G06Q 20/405

(57) ABSTRACT

The invention concerns a computer executable method for a computer executable method for managing an exception of a transaction in a transaction transmission network. The method is characterized in that it comprises computer executable steps for validating the transaction using at least one rule selected according to at least one stakeholder of the transaction, detecting the exception, creating an object comprising data of the exception, identifying at least one service adapted for immediate resolution of the exception, and identifying at least one service provider capable of altering the functionality of the source of the transaction to produce transactions that are compliant with the at least one rule. An arrangement and a computer storage medium are also disclosed.

### BACKGROUND

A transaction network, e.g. a network capable of transmitting business transactions, such as purchase orders and invoices between buyers and sellers, needs to be able to ensure the validity of the transactions that are accepted into the network.

In a business transaction network that has a large number of different sources and destinations (e.g. interfaces) for data and where each combination of source and destination may have its own requirements about the data format and content of the transaction, exceptions are bound to happen. Unhandled exceptions are not allowed to remain in the network as the transactions of the exceptions comprise business critical information that must be processed by the recipient of the transaction and/or the services of the transaction network in due time. Therefore an exception handling mechanism is needed that is sufficient for all sources of the transaction network to handle the exceptions efficiently in both short term and long term.

It is an object of the present invention to disclose a computer executable method, a computer program and/or a computer arrangement for efficiently managing exceptions in a business transaction network.

### BRIEF DESCRIPTION OF THE INVENTION

An aspect of the invention is a computer executable method for managing an exception of a transaction using at least one computer in a transaction transmission network. The method may be characterized in that it comprises computer executable steps for validating, by the computer, the transaction using at least one rule selected according to at least one stakeholder of the transaction, detecting, by the computer, the exception, creating, by the computer, an object comprising data of the exception, identifying, by the computer, at least one service adapted for immediate resolution of the exception, and identifying, by the computer, at least one service provider capable of altering the functionality of the source of the transaction to produce transactions that are compliant with the at least one rule.

In an embodiment, the method further comprises the step of sending at least one invitation notification to invite a user representing a stakeholder of the transaction to resolve the exception using the service identified for immediate resolution of the exception.

In an embodiment, the method comprises the step of notifying the at least one service provider about the exception. The method may further comprise the step of calculating statistical and/or financial information about the exception. Yet further, the method may comprises performing the notification step if the calculated statistical and/or financial information exceeds a threshold value. In an embodiment, the method may also comprise the step of prioritizing a plurality of exceptions according to the calculated statistical and/or financial information.

Another aspect of the present invention is an arrangement comprising at least one server computer. The arrangement is adapted to comprise computer executable means for performing the steps of at least one of the methods disclosed herein. Therefore, an aspect of the invention may be e.g. an arrangement for managing an exception of a transaction using at least one computer in a transaction transmission network. The arrangement may be characterized in that it comprises computer means for validating the transaction using at least one rule selected according to at least one stakeholder of the transaction, detecting the exception, creating, by the computer, an object comprising data of the exception, identifying at least one service adapted for immediate resolution of the exception, and identifying at least one service provider capable of altering the functionality of the source of the transaction to produce transactions that are compliant with the at least one rule.

Yet another aspect of the present invention is a tangible computer readable memory medium comprising a computer program product. The product is adapted to comprise computer executable instructions for the purpose of performing at least one combination of steps of at least one of the methods disclosed herein. Therefore, an aspect of the invention may be e.g. a tangible computer storage medium comprising computer executable program code for managing an exception of a transaction using at least one computer in a transaction transmission network. The computer program code may be characterized in that it comprises instructions for validating the transaction using at least one rule selected according to at least one stakeholder of the transaction, detecting the exception, creating, by the computer, an object comprising data of the exception, identifying at least one service adapted for immediate resolution of the exception, and identifying at least one service provider capable of altering the functionality of the source of the transaction to produce transactions that are compliant with the at least one rule.

### DRAWINGS

Some preferred embodiments of the invention are described below with references to accompanied figures, where:

FIG. 1 depicts an arrangement of servers according to an embodiment of the present invention,

FIG. 2a illustrates some functional components of preferred embodiment of the present invention,

FIG. 2b illustrates some entities of a preferred embodiment of the present invention,

FIG. 3a shows as a flow chart the steps of a method of managing an exception according to a preferred embodiment of the present invention,

FIG. 3b shows as a flow chart the steps of a method of validating a transaction according to a preferred embodiment of the present invention,

FIG. 3c shows as a flow chart the steps of a method of remedying a transaction according to a preferred embodiment of the present invention,

FIG. 3d shows as a flow chart the steps of a method of routing an exception to a system integrator according to a preferred embodiment of the present invention, and

FIG. 4 depicts functional components of a computer usable as the computer of various embodiments of the present invention.

### DETAILED DESCRIPTION OF THE INVENTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

Some embodiments of the present disclosure may include one or more application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. An API may also implement functions having parameters, variables, or pointers. An API may receive parameters as disclosed or other combinations of parameters. In addition to the APIs disclosed, other APIs individually or in combination can perform similar functionality as the disclosed APIs.

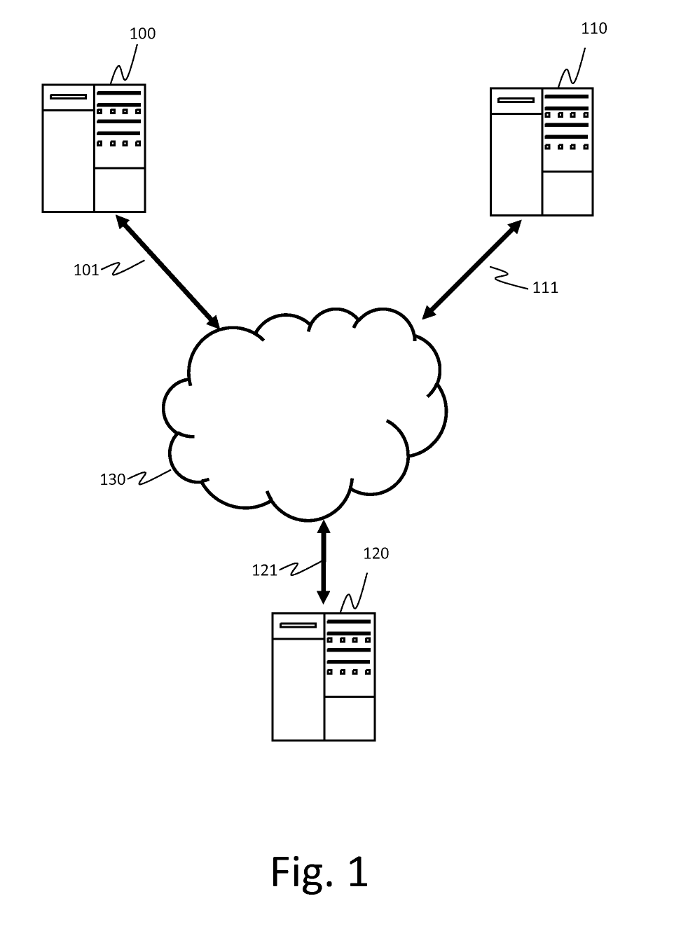

FIG. 1 depicts a computer and data communication arrangement according to a preferred embodiment of the present invention. The arrangement comprises a data communication network, e.g. a TCP/IP network, e.g. the Internet 130 to which a plurality of server computers, virtual or real, may be communicatively connected. In the shown embodiment, the network may comprise at least one, preferably a plurality of server computers that act as transaction sources 100 connected to the network 130 using a communication connection 101. In an embodiment, the transaction source is an application service, e.g. an invoicing service that creates transactions to be sent to the network 130. In another embodiment, the transaction source is a routing service that accepts the transaction from another system, e.g. an invoicing system of a business organization, and forwards it to the network 130.

The network further comprises at least one, preferably a plurality of server computers that act as transaction destinations 110 connected 111 to the network 130 using a communication connection 111. In an embodiment, the destination 110 is an application service, e.g. an invoice processing system of a buyer organization. In another embodiment, the transaction destination is a routing service that accepts the transaction from the network and forwards it to another system, e.g. the invoice processing system of a buyer organization. In yet another embodiment, the transaction destination is a value-add service provider that is arranged to receive transactions from the network for the purpose of providing a value-add service, e.g. a financing service for another entity in the network, e.g. the sender of the invoice.

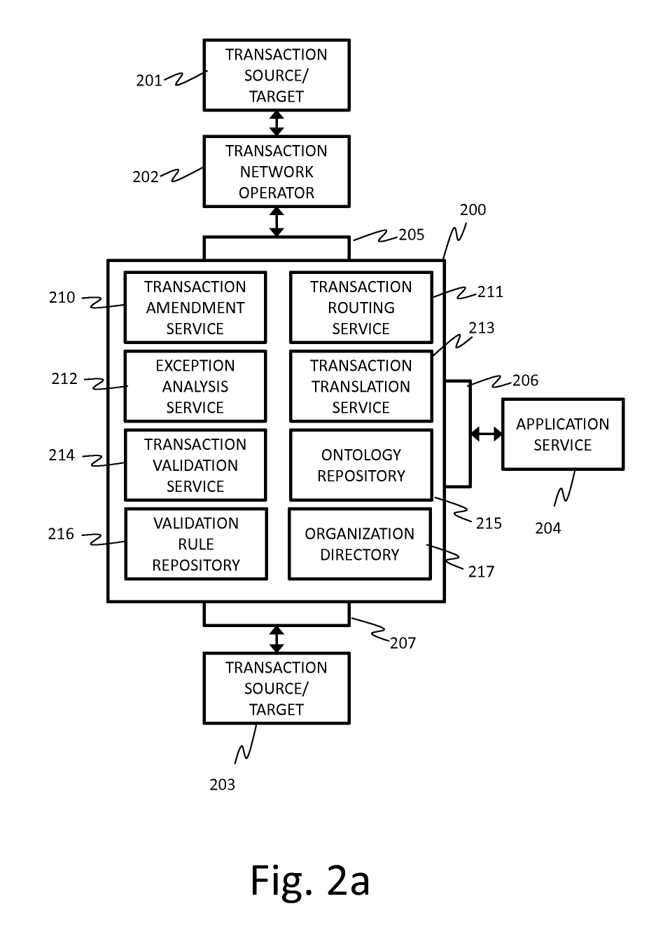

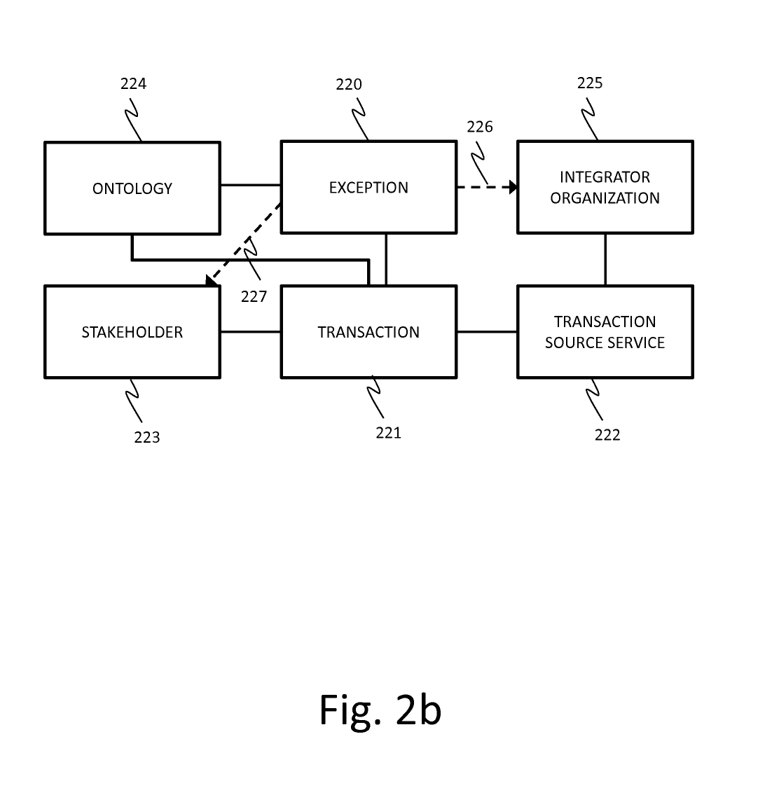

Finally, the network comprises at least one server computer 120 communicatively connected 121 to the network 130. The server computer 120 provides services of a service network operator. An exemplary set of services of an embodiment of the present invention is illustrated e.g. in the FIG. 2a of this disclosure. In a preferred embodiment, the server computer 120 receives transactions from the sources of transactions 100 and forwards transactions to at least one destination of transactions 110. The server computer 120 further manages information about the configuration of the network, e.g. the requirements and capabilities of interfaces used by the sources and destinations of the transactions. Yet further, the server computer monitors and analyses the transaction traffic in the network for the purpose of facilitating establishing business processes between transaction sources and destinations.

The server computers described herein may be e.g. physical servers or virtual servers known to a person skilled in the art.

FIG. 2a depicts an arrangement of some functional components, e.g. software services executable on server computers connected to a data communication network, according to a preferred embodiment of the present invention. The arrangement comprises a collection of services adapted to provide the transaction transmission service 200 of some preferred embodiments of the present invention. The transaction transmission service 200 is adapted to transmit business transactions, e.g. purchase orders and/or invoices, to/from the stakeholders of the transactions 201-204 via data communication interfaces 205-207. The data communication interfaces may be implemented using suitable technologies known to a person skilled in the art. For example, they may utilize TCP/IP and HTTP protocols and HTML or XML data formats. The physical interface may comprise e.g. suitable WLAN or Ethernet technologies.

In a preferred embodiment, the stakeholders of the transactions may be transaction sources and targets, e.g. buyers (e.g. 203) and sellers (e.g. 201), transaction network operators 202 and/or providers of application services 204. The transaction sources and targets 201, 203 typically are applications or application services used by the companies (buyers and sellers) participating in the transaction network. Such applications may be e.g. order processing systems of sellers and invoice processing systems of buyers. Such system 203 may be directly connected to the transaction transmission service 200 via a data communication interface 207 or the system 201 may be connected to the transaction transmission service via a transaction network operator 202. The transaction network operator 202 typically implements a data communication interface to the various systems 201 of the customer organization that can act as a source or a target of transactions and communicates with the transaction transmission service using some commonly agreed standard format and protocol. In a preferred embodiment, transaction sources/targets 203, that are provided as SaaS (Software-as-a-Service) connect directly to the transaction transmission network. On-site installed software applications 201 typically interface the network via an operator 202. Transactions may be delivered also to application service providers 204 and new transactions or amendments to existing ones or supplementary data to transactions may be accepted into the transaction transmission network 200 from such application service providers.

In a preferred embodiment, the transaction transmission service 200 comprises a plurality of component services. The transaction routing service 211 is adapted to accept a transaction and determine at least one recipient for it. For example, the routing service 211 may accept a transaction from the transaction source 203 and route it to an application service 204 and to an operator 202 that transfers it further to the recipient 201.

Transaction translation service 213 is adapted to translate a transaction from a format to another format. In a preferred embodiment, the translation service accepts, via the data communication interface (205 or 207) a standard or proprietary formatted transaction from a transaction source (e.g. 203) and translates it into an internal format, which may also be a standard format, e.g. UBL (Universal Business Language) format. In another embodiment, the translation service accepts a transaction having the internal format and translates it into a proprietary or standard format for delivery to a transaction target (e.g. 201).

Ontology repository 215 comprises the information, e.g. conversion rules, required to translate data into the internal standard format. In a preferred embodiment, the ontology is based on a broad standard format, e.g. UBL. The information of the ontology repository 215 is also usable for associating a semantic meaning for the various data elements of various business documents (transactions). In a preferred embodiment, the exceptions managed by the service 200 are expressed using the ontology (a set of definitions of a formal vocabulary).

Organization directory 217 comprises contact and other information of the various stakeholders 201, 202, 203, 204 of the transactions of the transaction transmission network 100. The organization directory may also comprise information about organizations capable of configuring/modifying transaction source and target systems and the interfaces they use. Such organizations may be e.g. system integrators or vendors of the transaction sources and targets. The organization information is usable e.g. by the transaction routing service 211 when determining the stakeholders for the incoming transactions. In a preferred embodiment, the organization information is also associable with validation rules applicable to the organizations of the network 100. The validation rules are stored in the validation rule repository 216. When validating a transaction by the transaction validation service 214, a plurality of rules is identified for execution from the repository, e.g. on the basis of the organization information. The rules may be organization (stakeholder 201-204) specific or they may have a broader scope, e.g. a country or a business area. The transaction validation service 214 executes the validation rules and, if any of the rules fail, creates an exception data object. The exception is formatted using the ontology (i.e. vocabulary and semantics of a broad standard, e.g. UBL) stored in the ontology repository 215.

The exception analysis service 212 accepts as input data the created exception, analyses the exception and determines suitable further processing steps for the immediate and/or long term resolution of the exception. Typically, there are two or more different steps required for a satisfactory solution.

Firstly, an immediate solution for the failed transaction is required. For that purpose, a preferred embodiment of the present invention comprises a transaction amendment service 210. The transaction amendment service is e.g. a web-based service comprising a user interface for correcting and/or amending the data of the failed business transaction. The amendment service may e.g. invite a user representing e.g. the source of the transaction to amend the transaction using the user interface of the service so that it passes the validation rules applicable to the transaction. In a preferred embodiment, the reason of the transaction failure is shown on the user interface using the information of the related exception.

Secondly, the occurrence frequency and other aspects related e.g. to the cost caused by the exception are analyzed by the analysis service 212. If the exception occurs frequently, it means that the deficient, manually amended transactions cause a significant cost to at least one participant of the transaction network and impair the efficient functioning of the entire network. In such case, it is desirable to have the root cause of the exception fixed. To find the suitable organization (e.g. a software vendor or system integrator) for the repair or amendment of the source of transactions, the analysis service identifies from the organization directory at least one organization that is associable with the system originating the insufficient data. In a preferred embodiment, the exception analysis service maintains some statistical information e.g. about the occurrence frequency of the exception. The analysis service may also compile some financial information, e.g. about the estimated cost of the occurred exceptions. This statistical and/or financial information may be used for prioritizing the exceptions for the identified vendor or integrator. For example, the frequently occurring exceptions should have a higher priority at the vendor than seldom occurring ones. The exception analysis service 212 may use e.g. the transaction routing service 211 to send the insufficient transactions and/or exceptions to the identified vendor or integrator.

If no resolution steps can be identified for the failed transaction, the analysis service 212 rejects the transaction completely and the transaction is returned with the exception data to the source of the transaction e.g. using the transaction routing service 211.

In a preferred embodiment, the transaction validation service 214 is executed synchronously when the transaction arrives at the transaction transmission network from the source of the transaction.

FIG. 2b depicts an exemplary high-level entity relationship diagram about some significant entities of a preferred embodiment of the present invention. The exception 220 is created e.g. by the transaction validation service 214. The format and content of the exception utilizes the ontology 224. In a preferred embodiment, the ontology utilizes terminology specified in a broad standard, e.g. UBL. The exception is associated with the transaction 221 (e.g. an invoice or a purchase order), whose validation failed. The transaction 221 is associable with a plurality of stakeholders 223. In a preferred embodiment, a stakeholder organization may be e.g. the sender or receiver of the transaction 221 or a service provider that provides e.g. a value-add application service subscribed by a stakeholder for the transaction. The transaction 221 is also associable with a transaction source service 222 from where the transaction was received into the transaction transmission network 100. The transaction source 222 may be associated with at least one integrator organization 225 that may receive requests regarding further development of the transaction source service.

In a preferred embodiment the exception 220 is analyzed using the exception analysis service 212 and based on the analysis, it is routed (assigned) 226, 227 to at least one suitable organization for further action. One such organization may be e.g. the originator (sender) of the transaction whose user may be authorized to manually fix or amend the failed transaction using a data entry service (e.g. 210 in FIG. 2a). Another such organization may be e.g. the system integrator 225 which is capable of amending the functionality of the transaction source service 222 in a manner that the later transactions will be successfully validated. A preferred embodiment of the invention comprises a notification service for sending notifications, e.g. e-mail messages, to at least one user of the organization to which the exception has been assigned 226, 227. The e-mail may comprise e.g. information about the exception 220 and the transaction 221 formatted in a user-readable manner.

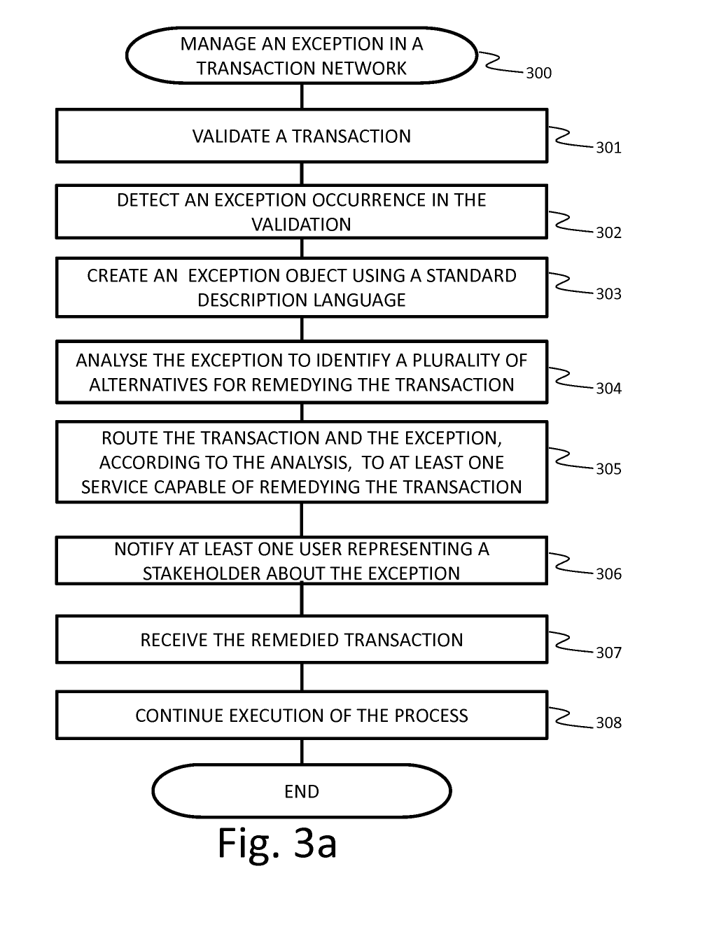

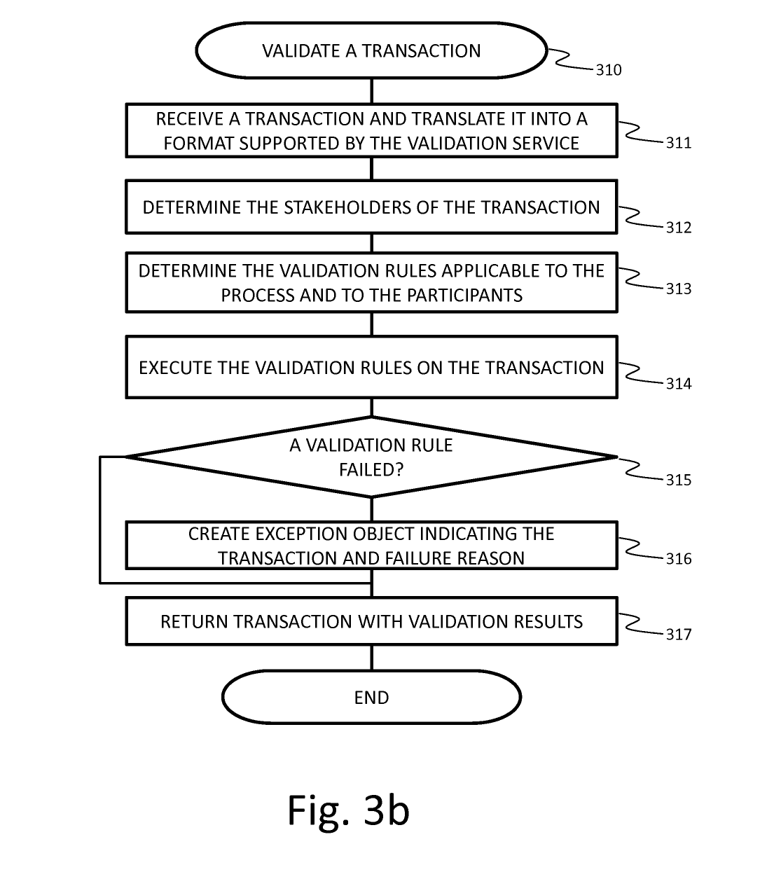

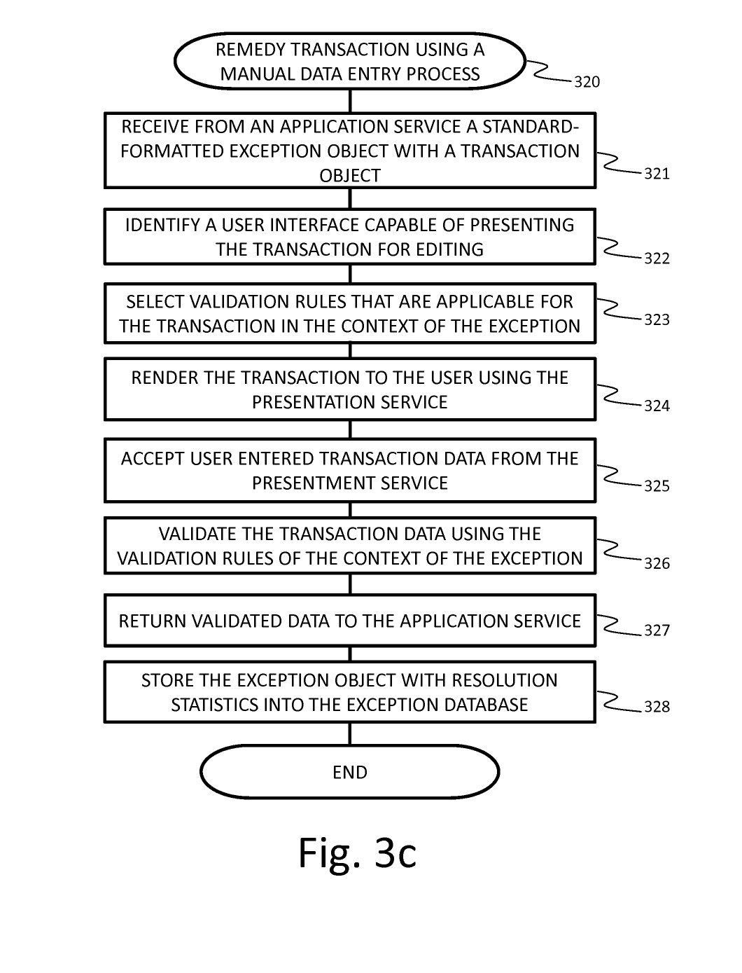

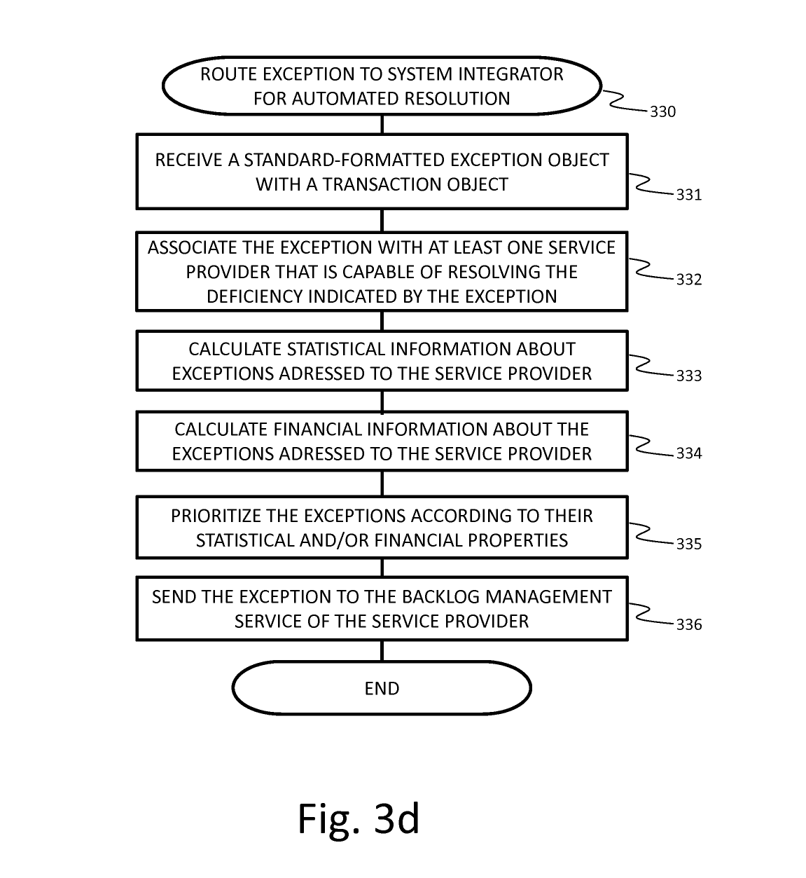

FIG. 3a shows in a flow chart a method of managing 300 an exception in a transaction transmission network according to a preferred embodiment of the present invention. In step 301 the transaction is validated using the transaction validation service 214. In the validation process, an exception is detected 302 and an exception object is created 303. The exception object utilizes the data format and content of an ontology 224 in that is commonly used in the transaction transmission service 200 of the transaction network 100. The ontology is preferably based on a broad business transaction standard, such as UBL. Next, the exception is analyzed 304 using the exception analysis service 212 to identify a plurality of alternatives for remedying the transaction. In step 305, the exception with the failed transaction is routed to at least one identified recipient. In step 306, at least one invitation notification is sent to invite a user representing the recipient stakeholder of the transaction to resolve the exception e.g. using the service identified for immediate resolution of the exception, e.g. the transaction amendment service 210. In step 307, the remedied transaction is received e.g. at the transaction routing service 211 and the processing of the transaction is continued 307, e.g. by routing the transaction to its intended recipient stakeholders(s), e.g. the buyer of an invoice and a service provider providing e.g. a financing service for the transaction.

In an embodiment, one possible service is a transaction presentment service adapted to display the failed transaction on a user interface and providing means for an authorized user to amend or correct the data of the transaction to make the transaction allowable by the validation rules applicable to the transaction. Another exemplary way for remedying the transaction is to notify a suitable system integrator organization about the occurrence of the exception. Such notification may be conditional. For example, the notification may be sent only, if a sufficient number of similar exceptions have occurred in the network. This way the system integrator may concentrate on improving the source of transactions with features that address a large number of exceptions whereas rarely occurring exceptions are handled using the manual correction via the transaction amendment (presentment) service 210.

FIG. 3b illustrates in more detail the method of validating a transaction 310 according to a preferred embodiment of the present invention. The method begins with the receiving of a transaction 311. The transaction is then translated into a format supported by the validation service. The translation service 213 advantageously utilizes the ontology repository 215 in the translation process. Next, the stakeholders of the transaction are determined in step 312. The stakeholders typically comprise the sender and receiver (e.g. 201, 203) of the transaction, operators (e.g. 202) participating in the transaction transmission process as well as providers of application services 204 subscribed for the transaction. Each of the stakeholder of the transaction may have its own requirements regarding the transaction. The requirements may be particular e.g. to the individual stakeholder or to some property of the stakeholder, e.g. the country of the stakeholder or the area of business where the stakeholder is in. The requirements are expressed in the preferred embodiment as validation rules. The rules that are applicable to the transaction and its stakeholders are identified in step 313. The rules are executed using the transaction data in step 314. If any of the validation rules fails 315, an exception object is created 316 about the transaction. The exception data object may contain any information necessary in the handling of the transaction. In an embodiment, the exception data object identifies the failed transaction, the missing/erroneous data field or other error in the transaction as well as the rule that created the exception. In step 317, the transaction is returned to a suitable service. The service may be e.g. the transaction routing service 211, if the transaction validation was successful and the transaction may be forwarded to its destinations in its current form. If the validation was unsuccessful and an exception occurred, the transaction may be forwarded to the exception analysis service 212 with the validation results, e.g. the exception object 220.

FIG. 3c shows a method for remedying a transaction using a manual data entry process 320. In step 321, the transaction amendment service 210 receives e.g. from the exception analysis service 212 a standard-formatted exception object and the related transaction object. In step 322, the transaction amendment service identifies, advantageously from a plurality of alternatives, a user interface that is capable of presenting the transaction for editing, i.e. for amending the missing data or correcting the erroneous data of the transaction. In an embodiment, the presentment service allows amendment/modification of only the data that has been identified as the cause of the exception. Next, the validation rules that are applicable for the transaction in the context of the exception are selected 323. In an embodiment, at least the rule that caused the creation of the exception object, is included in the selected set of rules. In another embodiment, all those rules that have been used in the validation of the transaction, are included in the selected set of rules. Next, in step 324, the data of the transaction is rendered to the user using the user interface selected by the presentment service for the transaction. Next, in step 325, the data entered by the user is accepted from the user interface to the data of the transaction object and the transaction is re-validated using the selected set of rules 326. Upon successful validation, the transaction is returned to a suitable service 327, e.g. the transaction routing service 211. Finally, the exception object with some resolution statistics data (e.g. user who resolved the exception and time spent at the resolution effort) may be stored 328 in the exception database of the transaction transmission service system 200.

FIG. 3d depicts a method for routing 330 an exception to a system integrator for requesting an automatic resolution for exceptions similar to the one detected by the validation service 214. In step 331, the transaction analysis service 212 receives an exception object and the related transaction object. The received exception is associated 332 with at least one service provider organization that is capable of resolving in the service the deficiency of the transaction indicated by the exception. In step 333, some statistical information is calculated about exceptions addressed to the identified service provider. The statistical information may comprise e.g. the occurrence frequency of similar exceptions in the network 100 and/or the number of stakeholders (senders) of transactions whose systems produce transactions that cause the exceptions. The analysis service 212 may also calculate estimates about financial effect 334 caused by the exceptions. Some costs may e.g. occur from the manual amendment of the incomplete data of from the inability of a service provider to provide a value-add service on the transaction because of the incompleteness of the transaction. In step 335, the exceptions addressed to the same recipient are prioritized according to their statistical and/or financial properties 335 and at least some prioritized exceptions are reported e.g. to the backlog management service of the application service provider 336. In an embodiment, such service may be provided to the application service providers of the network as a component service of the transaction transmission service 200 (not shown in figure).

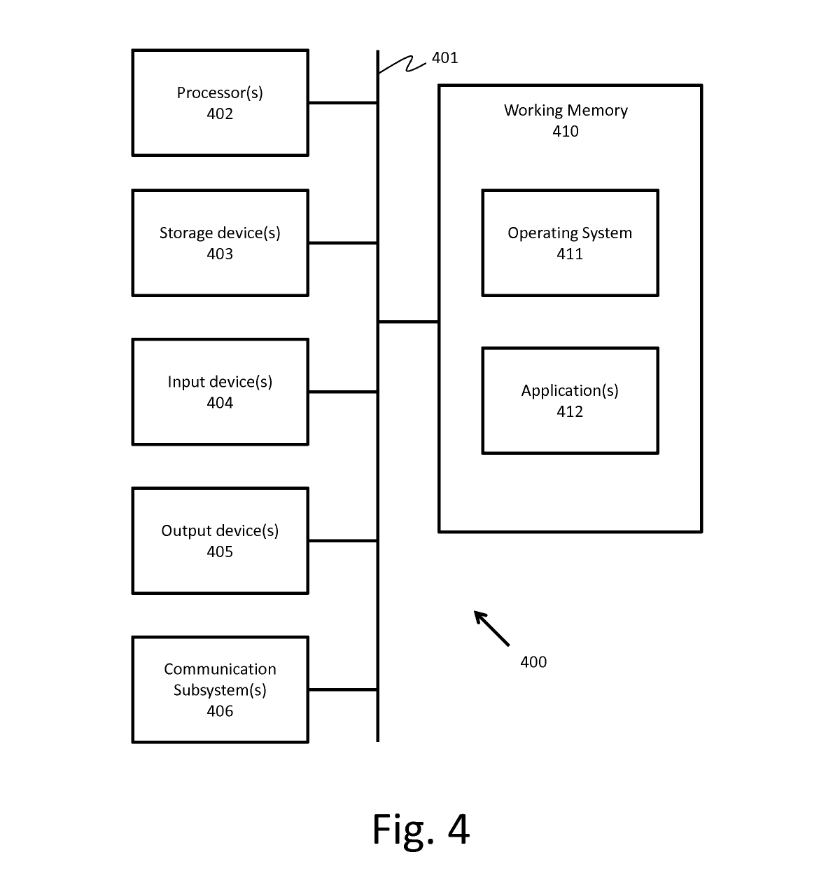

FIG. 4 shows a schematic illustration of one embodiment of a computer system that can perform the methods of the described embodiment. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 401 (or may otherwise be in communication, as appropriate). The hardware elements can include one or more processors 402, communication subsystems 403, one or more input devices 404, which can include without limitation a mouse, a keyboard and/or the like; and one or more output devices 405, which can include without limitation a display device, a printer and/or the like. The computer system 400 may further include (and/or be in communication with) one or more storage devices 403. The computer system 400 also can comprise software elements, shown as being located within the working memory 410, including an operating system 411 and/or other code, such as one or more application programs 412, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-method of an embodiment of the present invention.

Although specific embodiments have been described and illustrated, the embodiments are not to be limited to the specific forms or arrangements of parts so described and illustrated.

1. A computer executable method for managing an exception of a transaction using at least one computer in a transaction transmission network, wherein the method comprises computer executable steps for:
validating the transaction using at least one rule selected according to at least one stakeholder of the transaction,
detecting the exception,
creating an object comprising data of the exception,
identifying at least one service adapted for immediate resolution of the exception, and
identifying at least one service provider capable of altering the functionality of the source of the transaction to produce transactions that are compliant with the at least one rule.

2. A method according to claim 1, wherein the method further comprises the step of sending at least one invitation notification to invite a user representing a stakeholder of the transaction to resolve the exception using the service identified for immediate resolution of the exception.

3. A method according to claim 1, wherein the method comprises the step of notifying the at least one service provider about the exception.

4. A method according to claim 3, wherein the method comprises the step of calculating statistical and/or financial information about the exception.

5. A method according to claim 4, wherein the method comprises performing the notification step if the calculated statistical and/or financial information exceeds a threshold value.

6. A method according to claim 4, wherein the method comprises the step of prioritizing a plurality of exceptions according to the calculated statistical and/or financial information.

7. An arrangement comprising at least one server computer for managing an exception of a transaction using at least one computer in a transaction transmission network, wherein the arrangement comprises computer means for:
validating the transaction using at least one rule selected according to at least one stakeholder of the transaction,
detecting the exception,
creating an object comprising data of the exception,
identifying at least one service adapted for immediate resolution of the exception, and
identifying at least one service provider capable of altering the functionality of the source of the transaction to produce transactions that are compliant with the at least one rule.

8. A tangible computer storage medium comprising computer executable program code for managing an exception of a transaction using at least one computer in a transaction transmission network, the computer executable program comprises instructions for:
validating the transaction using at least one rule selected according to at least one stakeholder of the transaction,
detecting the exception,
creating an object comprising data of the exception,
identifying at least one service adapted for immediate resolution of the exception, and
identifying at least one service provider capable of altering the functionality of the source of the transaction to produce transactions that are compliant with the at least one rule.
